(19) United States
(12) Patent Application Publication
(10) Pub. No.: US 2008/0019754 A1
(43) Pub. Date: Jan. 24, 2008

(54) Method and apparatus for producing a security feature on a printing form, imaging device for producing a security feature, machine for processing material, security feature, printing form and printed product

(75) Inventors: Martin Schmitt-Lewen, Heidelberg (DE); Bernd Vosseler, Dossenheim (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/880,159

(22) Filed: Jul. 20, 2007

(30) Foreign Application Priority Data
Jul. 20, 2006 (DE) 10 2006 033 626.7

(51) Int. Cl. B41J 11/44

(52) U.S. Cl. 400/76

(57) ABSTRACT

A method for producing a security feature on a printing form includes providing an imaging device, particularly a laser device, having a feed, and varying the feed of the imaging device to produce the security feature on the printing form. The variation of the feed can be carried out periodically or randomly, for example, and produces a light-dark pattern as a visual impression. The security feature can only be reproduced with knowledge of the feed variation. An apparatus for carrying out the method, an imaging device, a printing machine including the apparatus, and a printing form and printed product produced thereby are also provided.

### CROSS-REFERENCE TO RELATED APPLICATION

This application claims the priority, under 35 U.S.C. §119, of German Patent Application DE 10 2006 033 626.7, filed Jul. 20, 2006; the prior application is herewith incorporated by reference in its entirety.

### BACKGROUND OF THE INVENTION

### Field of the Invention

The invention relates to a method for producing a security feature on a printing form by using an imaging device. Furthermore, the invention relates to a method for using an imaging device for producing a security feature on a printing form. Additionally, the invention relates to an apparatus for producing a security feature on a printing form, the apparatus including at least one imaging unit. The invention also relates to a machine for processing printing material. Furthermore, the invention relates to a security feature for use in printing technology. Additionally, the invention relates to a printing form having a security feature produced by imaging and to a printed product having a security feature produced by printing.

International Application No. WO 01/87632 has disclosed a method for producing a security feature on a printing form by using an imaging device. International Application No. WO 01/87632 describes the production of a security feature, in which halftone dots are disposed with an offset with respect to the ideal position thereof within the security feature. At the edges of the security feature, a gradual transition region is created which prevents the security feature from standing out from the background. However, no description is given in that publication as to how the halftone dots disposed with an offset are produced. In particular, no description is given as to how the imaging method itself is changed. The security feature that is described has the disadvantage that it can be reproduced by high resolution scanning, assuming the presence of appropriate technical equipment with relative effort.

### SUMMARY OF THE INVENTION

It is accordingly an object of the invention to provide a method and an apparatus for producing a security feature on a printing form, an imaging device for producing a security feature, a machine for processing printing material, a security feature, a printing form and a printed product, which overcome the hereinafore-mentioned disadvantages of the heretofore-known devices and methods of this general type.

It is a further or alternative object of the invention to provide an improvement over the prior state of the art, wherein a security feature is produced which, even with appropriate technical equipment, cannot be reproduced with relative effort or expense.

It is a further or alternative object of the invention to provide an improvement over the prior state of the art, wherein a security feature is produced simply and cost-effectively and likewise ensures a high security standard.

With the foregoing and other objects in view, there is provided, in accordance with the invention, a method for producing a security feature on a printing form, which comprises providing an imaging device having a feed, and varying the feed of the imaging device to produce the security feature on the printing form.

In accordance with another mode of the method according to the invention, the feed is carried out in accordance with a non-constant profile selected from a group of profiles consisting of periodic profiles, non-periodic profiles, and randomly generated profiles.

With the objects of the invention in view, there is also provided an imaging device, comprising a feed being variable for producing a security feature on a printing form.

With the objects of the invention in view, there is furthermore provided an apparatus for producing a security feature on a printing form. The apparatus comprises an imaging device having at least one imaging unit, and a control device for driving a feed drive for a feed of the imaging device so that the feed is carried out in a varied manner.

In accordance with an additional feature of the apparatus according to the invention, the feed is carried out in accordance with a non-constant profile selected from a group of profiles consisting of periodic profiles, non-periodic profiles, and randomly generated profiles.

With the objects of the invention in view, there is also provided a machine for processing printing material, in particular, a printing press or a sheet-processing rotary printing press for lithographic offset printing, comprising an apparatus for producing a security feature on a printing form. The apparatus includes an imaging device having at least one imaging unit, and a control device for driving a feed drive for a feed of the imaging device so that the feed is carried out in a varied manner.

With the objects of the invention in view, there is additionally provided a security feature for use in printing technology. The security feature comprises imaging lines disposed offset with respect to respective ideal positions thereof.

With the objects of the invention in view, there is also provided a printing form, comprising a security feature produced by imaging. The security feature includes imaging lines disposed offset with respect to respective ideal positions thereof.

With the objects of the invention in view, there is furthermore provided a printed product comprising a security feature produced by printing. The security feature includes imaging lines disposed offset with respect to respective ideal positions thereof.

In accordance with a concomitant feature of the invention, the security feature of the printed product is disposed in a gray area.

Thus, a method is provided according to the invention for producing a security feature on a printing form by using an imaging device, the method being distinguished by the fact that the security feature is produced by varying the feed of the imaging device.

The variation in feed according to the invention, that is to say the production of the security feature by variable-feed imaging or by the variable-feed production of imaging lines, leads to a security feature which cannot be reproduced without any knowledge of the feed variation used or only with a disproportionately high (computational) effort and which therefore, despite the simple and cost-effective production, ensures a very high security standard.

A further development of the apparatus according to the invention, which is advantageous with regard to a variable feed and is therefore preferred, can be distinguished by the fact that the feed is carried out in accordance with a non-constant profile from the group of profiles including periodic profiles, non-periodic profiles, and randomly generated profiles.

An imaging device may be used according to the invention for generating a security feature on a printing form. The security feature is produced by varying the feed of the imaging device.

An apparatus according to the invention for producing a security feature on a printing form, includes an imaging device having at least one imaging unit, and is distinguished by the fact that the apparatus includes a control device which drives a feed drive for the feed of the imaging device in such a way that the feed is carried out in a variable manner.

A further development of the apparatus according to the invention, which is advantageous with regard to a variable feed and is therefore preferred, can be distinguished by the fact that the feed is carried out in accordance with a non-constant profile from the group of profiles including periodic profiles, non-periodic profiles, and randomly generated profiles.

A machine for processing printing material in accordance with the invention, in particular a printing press or sheet processing rotary printing press for lithographic offset printing, is distinguished by an apparatus according to the invention described hereinabove.

A security feature according to the invention for use in printing technology is distinguished by the fact that the security feature includes imaging lines which are disposed offset with respect to the respective ideal position thereof.

A printing form according to the invention is distinguished by at least one security feature according to the invention described hereinabove and produced by imaging.

A printed product according to the invention is distinguished by at least one security feature according to the invention described hereinabove and produced by printing.

A further development of the apparatus according to the invention, which is advantageous with regard to optical perceptibility and is therefore preferred, is distinguished by the fact that the security feature is disposed in a gray area.

The invention and the advantageous developments of the invention that are described herein also constitute advantageous developments of the invention in any desired combination with one another.

Other features which are considered as characteristic for the invention are set forth in the appended claims.

Although the invention is illustrated and described herein as embodied in a method and apparatus for producing a security feature on a printing form, an imaging device for producing a security feature, a machine for processing printing material, a security feature, a printing form and a printed product, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, plan view illustrating the production of a security feature according to the invention; and

FIG. 2 is a plan view of a printed product having a preferred exemplary embodiment of a security feature according to the invention.

### DETAILED DESCRIPTION OF THE INVENTION

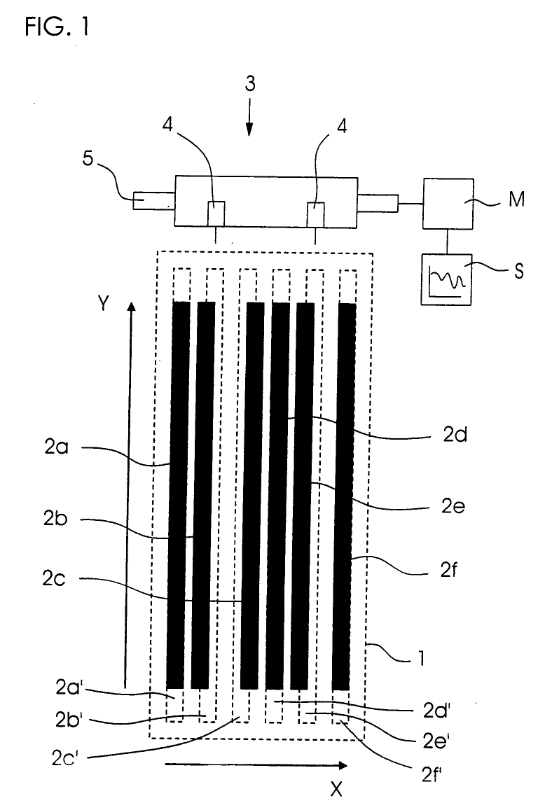

Referring now to the figures of the drawings in detail and first, particularly, to FIG. 1 thereof, there is seen an enlarged illustration of a section of imaging lines of an imaged printing form 1, for example a printing plate or a surface of a printing form cylinder. By way of example, sections of six lines 2a to 2f are shown, which are oriented parallel to a Y direction. In this exemplary embodiment, the Y direction corresponds to a so-called fast scan direction of an internal or external drum exposer. The imaging lines can be formed as uninterrupted lines or as interrupted or uninterrupted lines assembled from imaging points (pixels).

The printing form 1 is preferably imaged and portrayed, respectively, in a so-called interleave method. The interleave method is based upon the use of an imaging device 3 and an imaging head, preferably a laser head, respectively, which is moved in an X direction at a constant feed speed and which has a plurality of imaging units 4 disposed at a spaced distance from one another in the X direction, preferably individual laser channels 4 of diode lasers or a plurality of laser channels 4 from diode laser bars. In this exemplary embodiment, the X direction corresponds to the so-called low scan direction of the internal or external drum exposer. Due to the simultaneous movement of the printing form 1 in the Y direction, for example, by rotating the exposer drum holding a curved printing form 1, and moving the imaging device 3 in the X direction, for example, by displacing the device 3 along a crossbeam 5, imaging lines 2a to 2f are produced on the printing form 1 in the form of helical lines, the helical lines being produced by various laser channels 4 coming to lie in one another. The control of the feed movement must, in this regard, take into consideration the distance between the individual laser channels 4. An extensive description of this imaging method can be found in German Published, Non-Prosecuted Patent Application DE 100 31 915 A1, corresponding U.S. Patent Application Publication No. US 2002/0005890 and U.S. Pat. No. 6,784,912.

The invention is not restricted, however, to the preferred interleave imaging method. Imaging with only a single laser channel 4 which is movable in the feed direction and of which the feed movement can be varied by appropriate driving is also conceivable. Such imaging is not readily possible, however, with the given technical equipment, i.e. with the given plate exposer applying the interleave method, that is to say, not readily possible without technical changes at the plate exposer. The possibility of forgery is thus made more difficult for a potential forger who has the same technical equipment.

The method according to the invention can, for example, be stored as a procedure that can be called up in the control device of a plate exposer, for example, the Suprasetter of Heidelberger Druckmaschinen AG, that uses the interleave method. Thus, the method according to the invention can advantageously be performed with already available CTP technology.

According to the invention of the instant application, the feed of the imaging device 3 in the X direction is preferably carried out continuously but with a variation, i.e. it is not carried out constantly but, for example, is varied periodically. FIG. 1 illustrates how the imaging lines 2a to 2f deviate from their respective ideal positions 2a′ to 2f′, produced under the assumption of constant feed, in or counter to the X direction, i.e. disposed offset from one another. The imaging lines 2a to 2f preferably have a width of about 10 micrometers and an ideal spacing of likewise about 10 micrometers. For example, the imaging line 2b is disposed before the ideal position 2b′ in the X direction by reducing the feed speed, and the imaging line 2c is disposed after the ideal position 2c′ in the X direction by increasing the feed speed. As is apparent in FIG. 1, the respective imaging line spacing can be changed by the feed variation.

An intermittent feed can also be provided instead of the preferred continuous feed. In this case, “variation of the feed” means that the feed is not carried out with constant step widths. Instead, the step widths or the number of fixed step widths is variable.

A control device S can be provided in order to drive a feed drive M of the imaging device. The variation of the feed in the X direction can be carried out, as mentioned hereinbefore, periodically, for example, sinusoidally, or else non-periodically, for example. Alternatively, the variation can also be carried out randomly by using a random number generator, preferably provided in the control device S. Likewise, alternatively, the variation can follow a specific speed profile, for example, calculated and stored, preferably stored in the control device S.

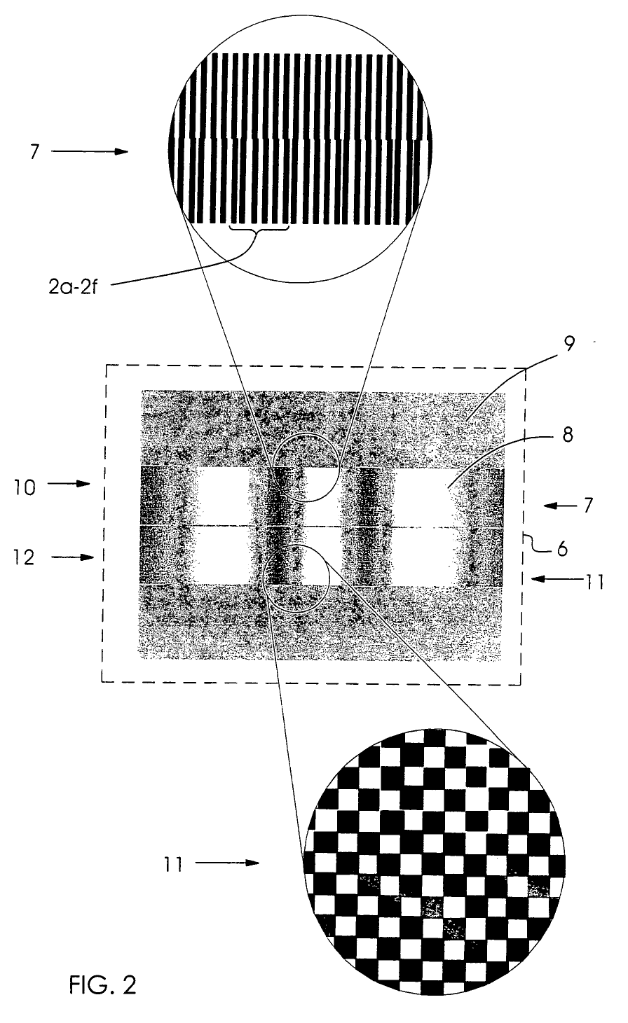

FIG. 2 illustrates a portion of a printed product 6. The portion of the printed product 6 in the middle of FIG. 2 has a printed security feature 7 of the printed product. The security feature 7 preferably has a gray area 8. The visual appearance of the gray area 8 is changed by the feeding variation during imaging and, in particular, has light and dark stripes 9 lying in the Y direction and a light-dark pattern 10 which extends in the X direction and is produced by the positioning or location of the imaging lines 2a to 2f deviating from the ideal position 2a′ to 2f′ in the X direction. Alternatively, other image contents of the printed product 6 can also be used for the placement of an appropriate security feature, but a gray area which is assembled from lines in the fast scan direction reacts very sensitively to a variation of the imaging line spacing and is therefore preferably used for the placement.

The security feature 7 produced in accordance with the invention can advantageously be used as a security feature for the following reason: although, given knowledge of the input variables (e.g. distance between two laser channels 4, line screen used, course or profile of the feed variation), the resultant, possibly visible stripe pattern 10 can be calculated, nevertheless back-calculation or reproduction from the stripe pattern 10 to the input variables or a specific feed variation with the given imaging variables and apparatus is not possible or possible at least only with disproportionately great effort. The secret information about the feed variation accordingly cannot be derived from the security feature 7 itself or not derived with tolerable effort. The method according to the invention is accordingly comparable with the method of the PGP encryption software, which is known and often used because of its high security, to the extent that an encryption produced with this software can be decrypted only with disproportionately great effort and expenditure of time. Thus, although a potential forger can analyze such a security feature, the data obtained, even if it originates from high resolution recordings (scans), cannot be used for forgery through the use of a corresponding feed variation, since the positioning of the imaging lines 2a to 2f is reproduced in the sub-halftone range and even in the sub-pixel range.

Consequently, even when using the same equipment for producing the printing products 6, for example, the same plate exposer, and even given the same effort, a potential forger cannot reproduce the security feature 7. This advantage will not be found in most of the security features known from the prior art. Instead, given the same technical equipment and the same effort, a potential forger is at least in the position of copying the security feature from the prior art.

In order to produce a printed product 6 having the security feature 7 produced in accordance with the invention, the procedure can be as follows. During the imaging of the printing form 1 for one color separation, an area at least of the size and shape of the security feature 7 is not imaged at the same time. In a separate imaging operation, this area is imaged while varying the feed, so that, for example, a gray area 8 with a light-dark pattern 10 is produced. All of the printed products 6 produced with this printing form 1 then have the security feature 7. If, then, a print from the printing original is kept as a reference, then later, by comparing individual prints with a reference print, conclusions can be drawn as to their authenticity. Through comparison with the reference print, it is possible to determine whether or not the questionable print was produced with the same printing form 1 as the reference print. In addition or alternatively, an electronic reference can also be stored for later authenticity tests. An electronic reference can, for example, be a high-resolution scan of the security feature 7 or possibly also a log of the feed variation. Furthermore, it is possible to distribute electronic references through secure data links, so that decentralized authenticity testing “on-site” is possible.

It is additionally possible to produce the feed variation, as mentioned hereinbefore, by a random number generator and not to store the random course of the feed variation, so even that printer who produced the original printed products secured against forgery is not in the position of producing the security feature actually used a second time, if the customer keeps the printing forms used at his or her premises or even destroys them.

Furthermore, a control area 11 which shows a light-dark pattern 12 corresponding to the light-dark pattern 10 of the security feature 7 can be applied to the printed product 6. However, the light-dark pattern 12 of the control area 11 is not produced by a feed variation but, for example, by an AM or FM screen and thus reproduces the optical impression of the security feature 7 only “for the eye”. To this end, the optical impression of the security feature 7 is calculated in advance and is produced through the AM or FM screen with a constant imaging feed, preferably in the first imaging pass. Given appropriate magnification, however, the difference between the control area 12, which is generally screened more coarsely, and the security feature 7 built up on a finer line screen, can be detected. Both in the case of photocopying and in the case of reproduction based on high resolution scanning, the optical impression of the control area 12 will deviate from that of the security feature 7, so that the presence of a forgery becomes detectable “at first glance”.

Finally, an electronic copy of the security feature 7 can be distributed electronically together with an electronic copy of the control area 12. The customer can then print out the control area with a conventional printer “on site” and compare the optical impression with the security feature 7 on the questionable product, in order to obtain a first impression of its authenticity. Alternatively, the customer can scan the security feature 7 in, with a conventional high-resolution scanner and compare it electronically with the electronic copy in order to be able to detect the presence of a forgery.

The following exemplary scenario is conceivable: during production, pharmaceutical packs are provided with security features 7 according to the invention, with it being possible for the security features 7 additionally to be time-dependent and/or product-dependent. Electronic references of the security features are distributed to pharmacists through secure data links. Consequently, when accepting delivery, the pharmacist can check the authenticity and possible manipulations to use-by dates by comparing the security features 7 found on the packs with the references.

The particular advantage of the method according to the invention and a security feature 7 produced in accordance with the invention, is to be found in the fact that even professional forgers with very good technical equipment are not in the position of copying the security feature according to the invention.

A further advantage is to be found in the fact that the method according to the invention is also suitable for printing large editions and, at the same time, can be carried out simply and cost-effectively.

Apart from being used in offset printing (sheet or web processing indirect planographic printing), the method according to the invention can also be used in flexographic and gravure printing, if a feed variation is made during the imaging.

Security features 7 according to the invention can be applied directly to predominantly security-relevant printed products. As an alternative to this, the security features 7 can also be applied to separate labels which are in turn applied to the products to be protected, for example adhesively bonded thereon.

1. A method for producing a security feature on a printing form, the method comprising the following steps:
providing an imaging device having a feed; and
varying the feed of the imaging device to produce the security feature on the printing form.

2. The method according to claim 1, which further comprises:
carrying out the feed in accordance with a non-constant profile selected from a group of profiles consisting of periodic profiles, non-periodic profiles, and randomly generated profiles.

3. An imaging device, comprising:
a feed being variable for producing a security feature on a printing form.

4. An apparatus for producing a security feature on a printing form, the apparatus comprising:
an imaging device having at least one imaging unit;
a feed drive for a feed of said imaging device; and
a control device for driving said feed drive to carry out said feed of said imaging device in a varied manner.

5. The apparatus according to claim 4, wherein said feed is carried out in accordance with a non-constant profile selected from a group of profiles consisting of periodic profiles, non-periodic profiles, and randomly generated profiles.

6. A machine for processing printing material, the machine comprising:
an apparatus according to claim 4.

7. The machine according to claim 6, wherein the machine for processing printing material is a printing press.

8. The machine according to claim 6, wherein the machine for processing printing material is a sheet-processing rotary printing press for lithographic offset printing.

9. A security feature for use in printing technology, the security feature comprising:
imaging lines disposed offset with respect to respective ideal positions of said imaging lines.

10. A printing form, comprising:
a security feature according to claim 9.

11. A printed product, comprising:
a security feature according to claim 9.

12. The printed product according to claim 11, wherein said security feature is disposed in a gray area.
